(19) United States
(12) Patent Application Publication
(10) Pub. No.: US 2018/0184468 A1
(43) Pub. Date: Jun. 28, 2018

(54) USER EQUIPMENT SUPPORTING ULTRA-RELIABLE LOW LATENCY COMMUNICATION SERVICE, USER EQUIPMENT SUPPORTING ENHANCED MOBILE BROADBAND SERVICE, AND BASE STATION

(71) Applicant: Institute For Information Industry, Taipei (TW)

(72) Inventors: Chun-Che CHIEN, Taipei City (TW); Hai-Han WANG, Taipei City (TW)

(21) Appl. No.: 15/808,611

(22) Filed: Nov. 9, 2017

Related U.S. Application Data
(60) Provisional application No. 62/438,444, filed on Dec. 22, 2016.

(51) Int. Cl. H04W 76/06; H04W 48/02; H04W 72/00; H04W 72/12; H04W 72/04

(52) U.S. Cl. CPC H04W 76/066; H04W 48/02; H04W 76/048; H04W 72/1284; H04W 72/0406; H04W 72/005

(57) ABSTRACT

A user equipment supporting ultra-reliable low latency communication service, a user equipment supporting enhanced mobile broadband service, and a base station are provided. The user equipment supporting ultra-reliable low latency communication service stores a plurality of preambles including a dedicated preamble, and performs the following operations: selecting a transmission resource from a share resource pool configured for the user equipment and at least one other user equipment; transmitting the dedicated preamble in a preamble resource corresponding to the transmission resource to make the base station suspend an allocation and transmission procedure of the transmission resource for the at least one other user equipment; and transmitting an uplink data in the transmission resource to make the base station transmit a response message to the user equipment after receiving the uplink data.

### PRIORITY

This application claims the benefit of priority based on U.S. Provisional Application Ser. No. 62/438,444 filed on Dec. 22, 2016, which is hereby incorporated by reference in its entirety.

### FIELD

The present invention relates to a user equipment supporting ultra-reliable low latency communication service, a user equipment supporting enhanced mobile broadband service and a base station. More particularly, the user equipment supporting the ultra-reliable low latency communication service preempts a transmission resource by transmitting a dedicated preamble so that a base station and at least one other user equipment capable of receiving the dedicated preamble suspend the use of the transmission resource.

### BACKGROUND

Application scenarios of the next generation of mobile communication system (which is generally called the 5G mobile communication system currently) mainly have ultra-reliable low latency communication (URLLC) service, enhanced mobile broadband (eMBB) service and massive machine type communication (mMTC) service. The URLLC service is mainly applied in scenarios, such as Internet of Vehicles and industrial control or the like, that have ultra-reliable low latency transmission requirements, e.g., applied in automatic driving, unmanned transportation and transfer robots or the like. Therefore, as compared to a user equipment supporting the eMBB service (which is later called an eMBB user equipment) or a user equipment supporting the mMTC service (which is later called an mMTC user equipment), a user equipment supporting the URLLC service (which is later called a URLLC user equipment) needs to transmit data to the base station more rapidly and immediately so as to satisfy the timeliness of data.

However, according to the specifications of various communication system standards currently available, if a user equipment intends to transmit data to a base station after having established a connection with the base station, then the user equipment needs to transmit an uplink resource request message (e.g., an uplink scheduling request (SR) of the LTE communication system) to the base station, wait allocation of an uplink resource by the base station, and then transmit data in the uplink resource only after the uplink resource is allocated to the user equipment by the base station. In this case, transmission requirements of the URLLC service for enabling the user equipment to transmit real-time data to the base station cannot be satisfied.

Accordingly, an urgent need exists in the art to provide a data transmission mechanism which satisfies transmission requirements of the URLLC service, thereby ensuring the data could be transmitted immediately.

### SUMMARY

An objective of certain disclosed embodiments is to provide a data transmission mechanism, which enables a URLLC user equipment to select a transmission resource from a share resource pool immediately and transmit a dedicated preamble allocated by a base station so that the base station suspends an allocation and transmission procedure of the transmission resource for other user equipments, thereby achieving the purpose of preempting the transmission resource. In this way, the URLLC user equipment is able to select a transmission resource on its own to directly perform data transmission without the need of requesting an uplink resource from the base station in advance, when the URLLC user equipment needs to transmit instant data. Moreover, the same transmission resource used by the URLLC user equipment will not be allocated to or used by other user equipments. Accordingly, the data transmission mechanism can satisfy the transmission requirements of the URLLC service and further improve the resource utilization ratio and transmission reliability without causing transmission resource collision.

The disclosure includes a user equipment supporting an ultra-reliable low latency communication (URLLC) service, which comprises a storage, a transceiver and a processor. The storage stores a plurality of preambles including a dedicated preamble. The processor is electrically connected to the storage and the transceiver and is configured to execute the following operations: selecting a transmission resource from a share resource pool that is configured for use by the user equipment and at least one other user equipment, the at least one other user equipment supporting the URLLC service or an enhanced mobile broadband (eMBB) service; transmitting the dedicated preamble in a preamble resource corresponding to the transmission resource via the transceiver so that a base station suspends an allocation and transmission procedure of the transmission resource for the at least one other user equipment after receiving the dedicated preamble; and transmitting an uplink data in the transmission resource via the transceiver so that the base station transmits a response message to the user equipment after receiving the uplink data.

The disclosure also includes a user equipment supporting an eMBB service, which comprises a storage, a transceiver and a processor. The processor is electrically connected to the storage and the transceiver and is configured to execute the following operations: receiving downlink control information in a physical downlink control channel (PDCCH) via the transceiver, the downlink control information indicating an uplink resource allocated by a base station; receiving a preemption notification message via the transceiver, and suspending an uplink data transmission performed by using the uplink resource according to the preemption notification message; and receiving a response message from the base station via the transceiver so as to perform the uplink data transmission according to the response message.

The disclosure additionally includes a base station which comprises a storage, a transceiver and a processor. The processor is electrically connected to the storage and the transceiver and is configured to execute the following operations: receiving a dedicated preamble in a preamble resource via the transceiver, the dedicated preamble being transmitted by a user equipment that supports a URLLC service; receiving an uplink data transmitted by the user equipment in a transmission resource corresponding to the preamble resource according to the dedicated preamble; suspending an allocation and transmission procedure of the transmission resource for at least one other user equipment according to the dedicated preamble, the at least one other user equipment supporting the URLLC service or an eMBB service; and determining whether the uplink data is correctly received so as to transmit a response message to the user equipment. The transmission resource is included in a share resource pool configured for use by the user equipment and the at least one other user equipment.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts an implementation scenario of data transmission between a user equipment 1 and a base station 3 according to the present invention;

FIG. 2 depicts an implementation scenario of data transmission among the user equipment 1, a user equipment 2 and the base station 3 according to the present invention;

FIG. 3 depicts another implementation scenario of data transmission among the user equipment 1, the user equipment 2 and the base station 3 according to the present invention;

FIG. 4 depicts another implementation scenario of data transmission among the user equipment 1, the user equipment 2 and the base station 3 according to the present invention;

FIG. 5 depicts another implementation scenario of data transmission among the user equipment 1, the user equipment 2 and the base station 3 according to the present invention;

FIG. 6 depicts an implementation scenario of data transmission among the user equipment 1, the user equipment 2, the base station 3 and a base station 4 according to the present invention;

FIG. 7 is a schematic view of the user equipment 1 according to the present invention;

FIG. 8 is a schematic view of the user equipment 2 according to the present invention; and

FIG. 9 is a schematic view of the base station 3 according to the present invention.

### DETAILED DESCRIPTION

In the following description, certain example embodiments will be explained. However, these example embodiments are not intended to limit the present invention to any particular example, embodiment, environment, applications or implementations described in these example embodiments. Therefore, description of these example embodiments is only for purpose of illustration rather than to limit the present invention.

It shall be appreciated that, in the following embodiments and the attached drawings, elements unrelated to the present invention are omitted from depiction; and dimensional relationships among individual elements in the attached drawings are illustrated only for ease of understanding, but not to limit the actual scale.

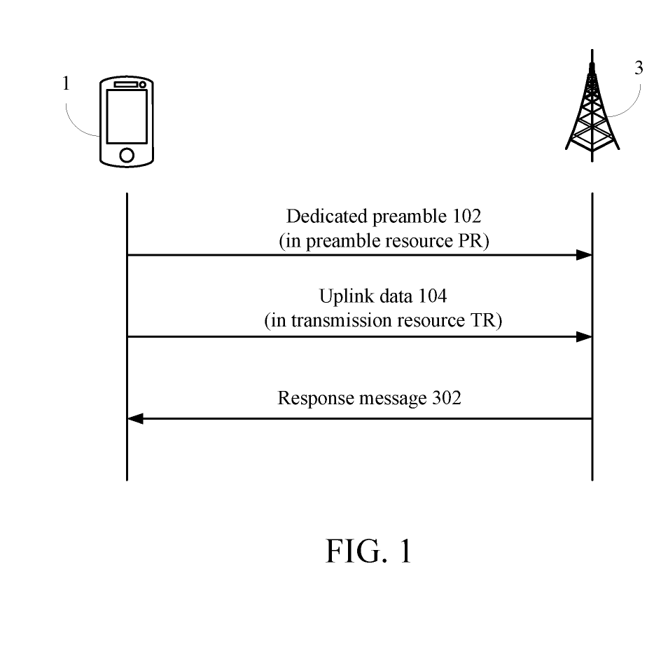

A first embodiment of the present invention is as shown in FIG. 1. FIG. 1 depicts an implementation scenario of data transmission between a user equipment 1 supporting ultra-reliable low latency communication (URLLC) service and a base station 3 according to the present invention. The user equipment 1 may be a smart phone, a tablet computer or any mobile communication device. The user equipment 1 stores a plurality of preambles including a dedicated preamble 102. The dedicated preamble 102 is allocated by the base station 3 after the user equipment 1 is connected to the base station 3, and the dedicated preamble 102 is used for purpose of identifying the URLLC user equipment 1. The user equipment 1 and the base station 3 are used in a wireless communication system which at least provides the URLLC service, the eMBB service or further provides the mMTC service.

In the present invention, in order to rapidly and immediately transmit data of the user equipment 1 to the base station 3, the user equipment 1 can directly select a transmission resource TR from a share resource pool and transmit the dedicated preamble 102 in a preamble resource PR corresponding to the transmission resource TR. Specifically, there is a correspondence relationship between the transmission resource TR and the preamble resource PR. For example, the preamble resource may be disposed in the same frequency band as the transmission resource TR but located in the several Orthogonal frequency-division multiplexing (OFDM) symbols or several time slots ahead of the transmission resource TR, i.e., the transmission resource TR directly follows the preamble resource PR. In this way, the user equipment 1 directly transmits an uplink data 104 in the transmission resource TR after transmitting the dedicated preamble 102. Thereafter, the base station 3 can learn the position of the transmission resource TR after receiving the dedicated preamble 102 in the preamble resource PR, and suspends an allocation and transmission procedure of the transmission resource TR for at least one other user equipment.

It shall be appreciated that, in order to enable the URLLC user equipment (e.g., the user equipment 1) to transmit uplink data immediately without the need of requesting the transmission resource from the base station 3 (i.e., in a uplink grant-free situation), the base station 3 may configure a share resource pool (which comprises a plurality of share resources) for use by the user equipment 1 and at least one other user equipment in the present invention. The at least one other user equipment may support the URLLC service or the eMBB service. In other words, the share resources in the share resource pool may be used by a plurality of URLLC user equipments and a plurality of eMBB user equipments. Moreover, the preamble resource PR of the present invention belongs to a non-collision resource pool (i.e., an orthogonal resource pool) pre-configured by the base station 3 based on the share resource pool, in order to ensure that the dedicated preamble transmitted by the URLLC user equipment does not overlap with the uplink resource allocated to the eMBB user equipment by the base station 3.

The dedicated preamble 102 serves as a preemption transmission request of the selected transmission resource TR. If the at least one other user equipment is a URLLC user equipment, the base station 3 suspends allocating the transmission resource TR selected by the user equipment 1 to the at least one other user equipment. If the at least one other user equipment is an eMBB use equipment, and the base station 3 has allocated an uplink resource which is at least partly overlapped with the transmission resource selected by the user equipment 1, then the base station 3 suspends the transmission with the at least one other user equipment (i.e., the base station will not treat the data received from the uplink resource as being transmitted by the other user equipment). If the base station 3 has not allocated an uplink resource to the at least one user equipment, then the base station 3 will not allocate the resource overlapped with the transmission resource TR to the at least one other user equipment.

After receiving the uplink data 104, the base station 3 may generate a response message 302 according to whether the uplink data 104 is correctly received (i.e., whether the uplink data 104 can be decoded correctly), and transmit the response message 302 to the user equipment 1. In other words, the response message 302 may carry receiving report information that indicates whether the base station 3 has correctly received the uplink data 104, e.g., carry an acknowledgement (ACK) identifier or a non-acknowledgement (NACK) identifier. Moreover, it shall be also appreciated by those of ordinary skill in the art that the dedicated preamble 102 of the present invention may also be used for channel measurement for the base station 3 to perform signal demodulation.

It shall be appreciated that, in this embodiment, the sizes of the preamble resource PR and the transmission resource TR are pre-configured by the base station 3 or defined by the communication system. However, in other embodiments, the base station 3 allocates a plurality of dedicated preambles 102 to the user equipment 1, and the dedicated preambles 102 may represent transmission resources TR of different sizes respectively. In this way, the base station 3 may determine the size of the transmission resources TR according to the received dedicated preambles 102 so as to retrieve the uplink data 104 from the transmission resources TR. In other words, different sizes of transmission resources TR represent the zones occupied by the transmission resources TR in frequency and time.

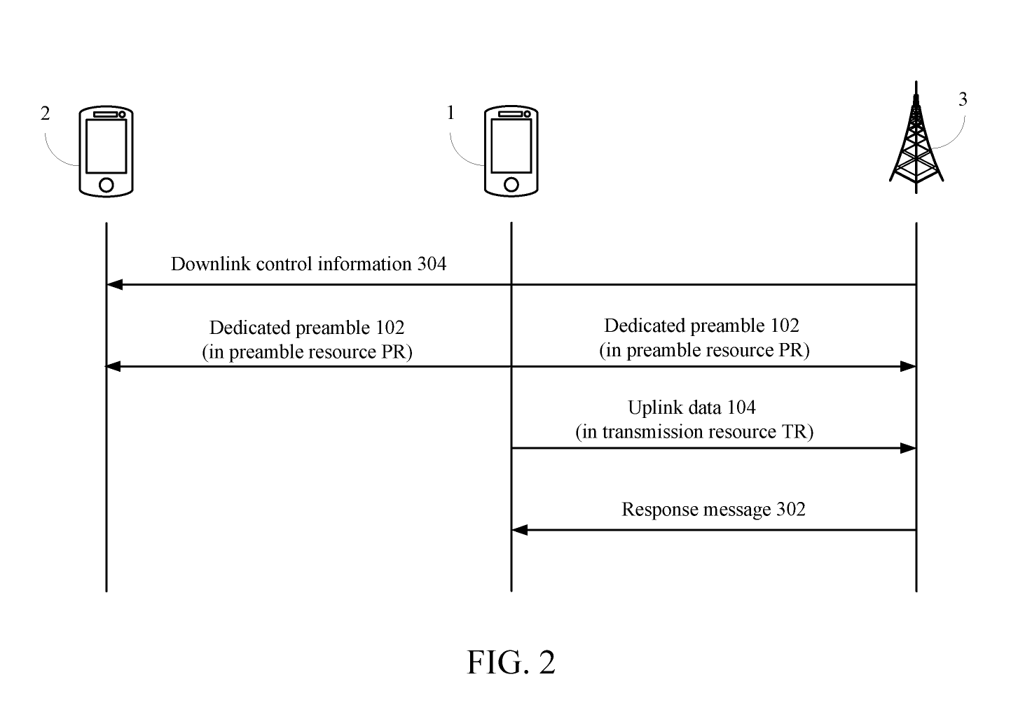

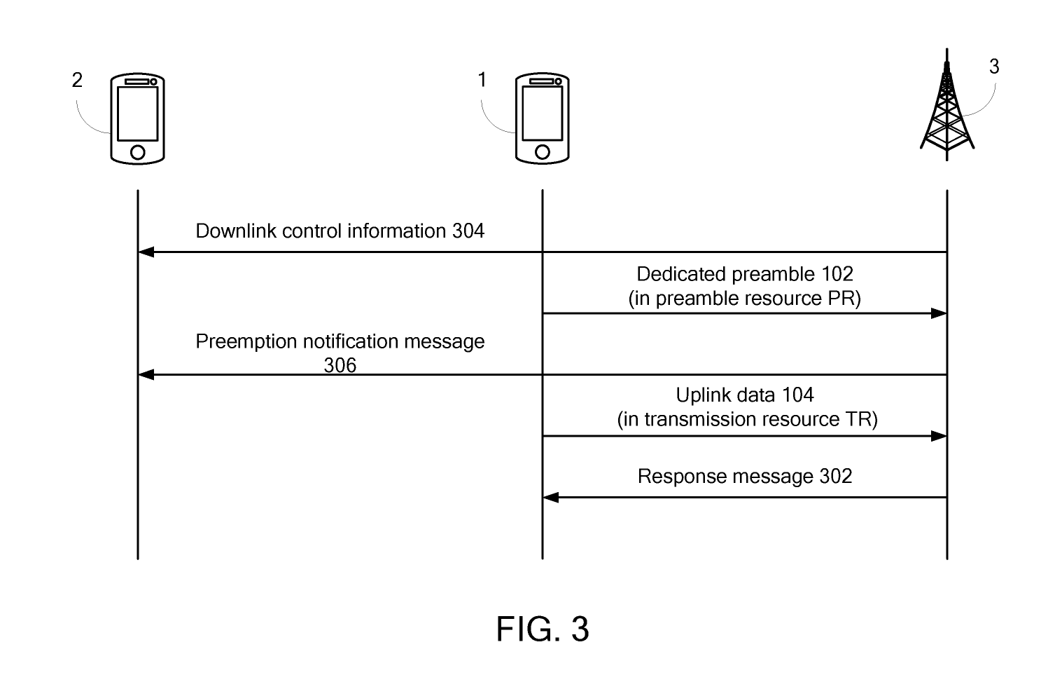

A second embodiment of the present invention is an extension of the first embodiment, as shown in FIG. 2 and FIG. 3. FIG. 2 depicts an implementation scenario of data transmission among the user equipment 1, a user equipment 2 and the base station 3 according to the present invention. FIG. 3 depicts another implementation scenario of data transmission among the user equipment 1, the user equipment 2 and the base station 3 according to the present invention. The user equipment 2 is an eMBB user equipment, and it may be a smart phone, a tablet computer or any mobile communication device.

First, referring to FIG. 2, the user equipment 1 may monitor in a physical downlink control channel (PDCCH) first to see if the base station 3 has allocated an uplink resource to the user equipment 2 before selecting the transmission resource in this embodiment. If the user equipment 1 finds downlink control information (DCI) 304 in the PDCCH, which indicates an uplink resource allocated to the user equipment 2 by the base station 3, then the user equipment 1 shall select a transmission resource TR that is different from the uplink resource allocated by the base station 3 based on the downlink control information 304 so as to prevent data collision in subsequent data transmission.

It shall be appreciated that, as shall be appreciated by those of ordinary skill in the art, the user equipment may search downlink control information in different search spaces (e.g., a UE-specific space, and a common search space) based on a DCI format in the PDCCH. Therefore, in order to enable the URLLC user equipment to learn the uplink resource allocated to the eMBB user equipment by the base station 3, information of the uplink resource allocated to the eMBB user equipment may be transmitted in the DCI format of the common search space, while other information that is more private to the eMBB user equipment is transmitted in the DCI format of the UE-specific space in the present invention, thereby ensuring a certain degree of information security. How the present invention transmits the downlink control information 304 shall be readily appreciated by those of ordinary skill in the art based on the above descriptions, and thus will not be further described herein.

After selecting the transmission resource TR, the user equipment 1 may indicate a preemption transmission request via the dedicated preamble 102 so as to prevent the base station 3 from allocating the transmission resource TR selected by the user equipment 1 to the user equipment 2. After receiving the dedicated preamble 102, the base station 3 may avoid allocating the resource overlapped with the transmission resource TR to the user equipment 2 or other user equipment according to the preemption transmission request indicated by the dedicated preamble 102. However, if the time point at which the base station 3 allocates the uplink resource is behind the time point at which the user equipment 1 monitors the PDCCH and selects the transmission resource TR, and the transmission resource TR selected by the user equipment 1 is partly overlapped with or completely the same as the uplink resource allocated by the base station 3, then the base station 3 suspends the data transmission with the user equipment 2 in the transmission resource based on the preemption transmission request (i.e., the base station will not treat the data received from the uplink resource as being transmitted by the user equipment 2).

The implementation scenario of FIG. 2 assumes that the user equipment 2 supports the function of receiving signals in an uplink channel, so the user equipment 2 can receive the dedicated preamble 102 transmitted by the user equipment 1. In this case, after receiving the dedicated preamble 102, the user equipment 2 can suspend the uplink data transmission in the uplink resource according to the preemption transmission request indicated by the dedicated preamble 102 so as to prevent transmission collision with the user equipment 1. In other words, when both the base station 3 and the user equipment 2 avoid using the transmission resource TR selected by the user equipment 1 based on the preemption transmission request, the user equipment 1 can transmit the uplink data 104 directly in the transmission resource TR. Similarly, after receiving the uplink data 104, the base station 3 may transmit a response message 302 to the user equipment 1 based on whether the uplink data 104 is correctly received (i.e., whether the uplink data 104 can be decoded correctly).

Furthermore, the implementation scenario of FIG. 3 assumes that the user equipment 2 has not received the dedicated preamble 102, or the user equipment 2 cannot receive the dedicated preamble 102 because it does not support the function of receiving signals in the uplink channel In this case, after receiving the dedicated preamble 102, the base station 3 generates and transmits a preemption notification message 306 to the user equipment 2. In this way, based on the preemption notification message 306, the user equipment 2 can stop using the uplink resource originally allocated by the base station 3 until the user equipment 1 has completed the transmission of the uplink data 104, or the user equipment 2 ignores the uplink resource originally allocated and wait re-allocation by the base station 3. It shall be appreciated that, the base station 3 may transmit the preemption notification message 306 to the user equipment 2 via one of unicast, multicast or groupcast. In other words, the preemption notification message 306 may be a dedicated dynamic downlink control message to directly instruct the user equipment 2 to perform corresponding operations, or may be a group dynamic downlink control message so that the user equipment 2 determines on its own whether it is associated with the message and then performs corresponding operations according to the preemption notification message 306.

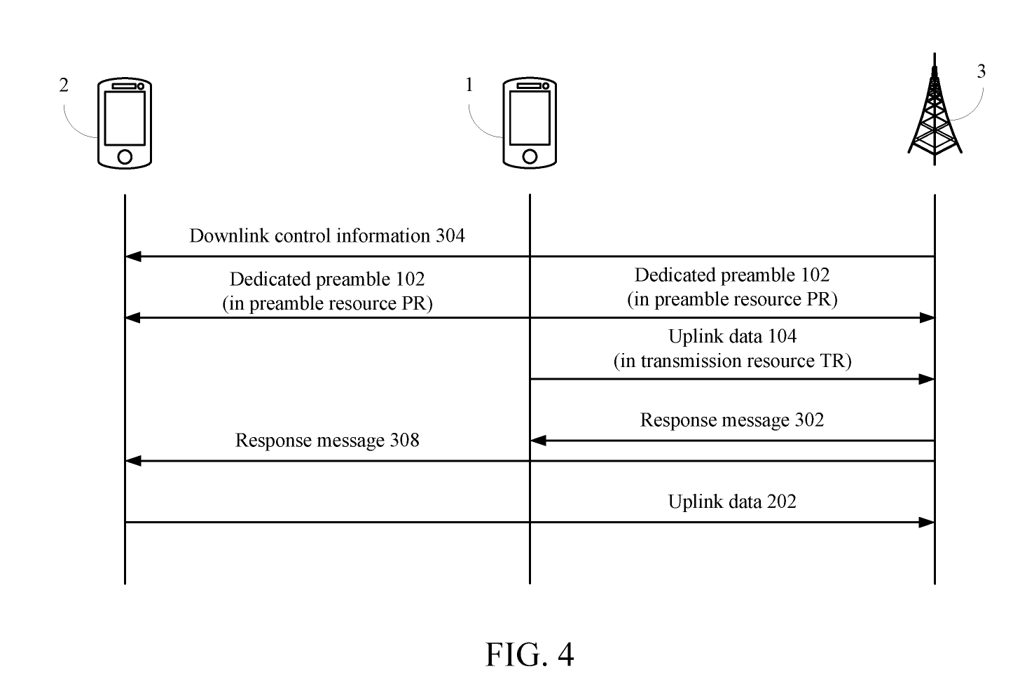

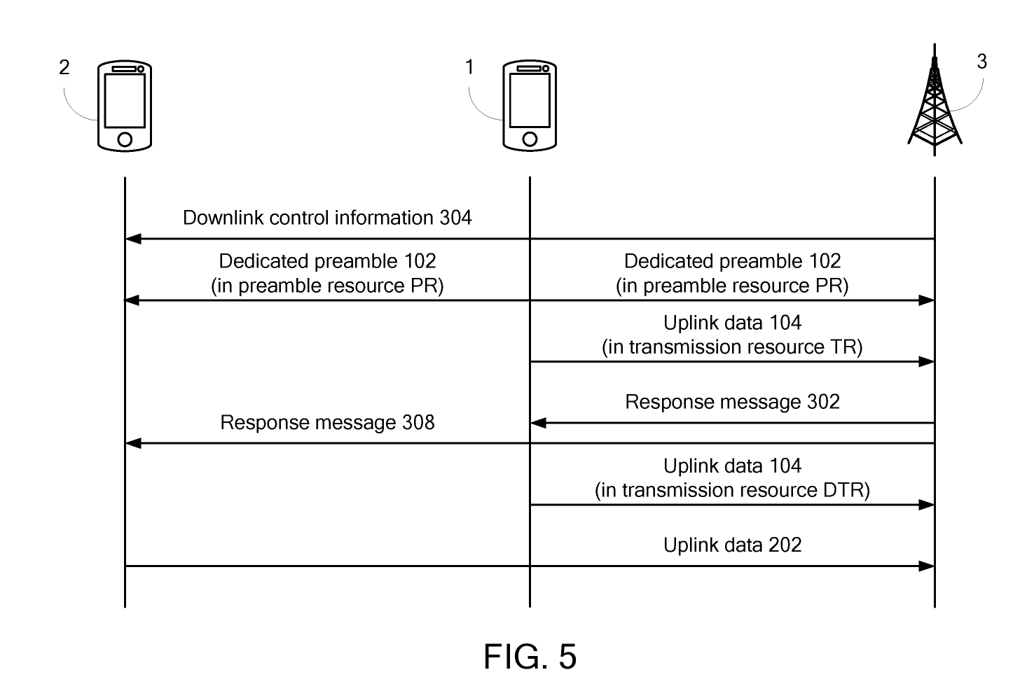

A third embodiment of the present invention is as shown in FIG. 4 and FIG. 5. FIG. 4 and FIG. 5 respectively depict other implementation scenarios of data transmission among the user equipment 1, the user equipment 2 and the base station 3 according to the present invention. The third embodiment is an extension of the second embodiment. As described previously, the response message 302 may indicate whether the base station 3 has correctly received the uplink data 104, e.g., carry an acknowledgement (ACK) identifier or a non-acknowledgement (NACK) identifier.

In the implementation scenario of FIG. 4, after the user equipment 1 has transmitted the uplink data 104, the base station 3 determines whether it has successfully received the uplink data 104. If the base station 3 determines that it has successfully received the uplink data 104, then the base station 3 notifies the user equipment 1 that the uplink data 104 has been successfully received via the response message 302. Additionally, the base station 3 further transmits another response message 308 to the user equipment 2. The response message 308 may carry preemption release information. In this way, if the uplink resource allocated originally is larger than the transmission resource TR selected by the user equipment 1 (i.e., a part of the uplink resource allocated is left for further use), then the user equipment 2 may continue to use the remaining uplink resource to transmit uplink data 202 based on the preemption release information.

Moreover, after receiving the uplink data 104, the base station 3 may also determine whether the uplink resource allocated to the user equipment 2 originally can still enable the user equipment 2 to transmit the uplink data 202. If the uplink resource cannot enable the user equipment 2 to transmit the uplink data 202 or the base station intends to perform re-allocation, then the base station 3 carries information of the uplink resource re-allocated in the response message 308 to inform the user equipment 2.

On the other hand, in the implementation scenario of FIG. 5, the base station 3 may allocate another transmission resource to the user equipment 1 if the base station 3 determines that it has not successfully received the uplink data 104 from the user equipment 1. Therefore, in addition to the receiving report information notifying the user equipment 1 that the uplink data 104 thereof has not been successfully received, the response message 302 further carries uplink resource allocation information indicating the position of another transmission resource of the user equipment 1 on the frequency band so that the user equipment 1 can re-transmit the uplink data 104 in another transmission resource DTS. Because the transmission resource DTS additionally allocated to the user equipment 1 by the base station 3 is a dedicated uplink resource, the probability of successfully transmitting the uplink data 104 by the user equipment 1 subsequently can be ensured to a certain degree.

In another embodiment, the dedicated preamble 102 may also indicate an uplink resource request or further indicate the size of an uplink resource required. In this case, no matter whether the base station 3 has successfully received the uplink data 104 in the transmission resource TR or not, the base station 3 will additionally allocate a dedicated transmission resource for use by the user equipment 1 to perform subsequent uplink data transmission, so the response message 302 further includes uplink resource allocation information. For example, the dedicated preamble 102 may serve as an uplink scheduling request (SR) of the LTE communication system so that the base station 3 accordingly allocates a dedicated transmission resource of a preset size, or the dedicated preamble 102 may further indicate a buffer status report (BSR) so that the base station 3 allocates a proper dedicated transmission resource accordingly. To achieve the aforesaid objective of resource request, the base station 3 may allocate a plurality of dedicated preambles 102 to the user equipment 1 so that the user equipment 1 selects one of these dedicated preambles 102 depending on the need thereof. In this way, these dedicated preambles 102 may not only represent the ID of the user equipment 1, but also indicate information such as the uplink resource request and size of the resource required or the like as have been preset or negotiated in advance.

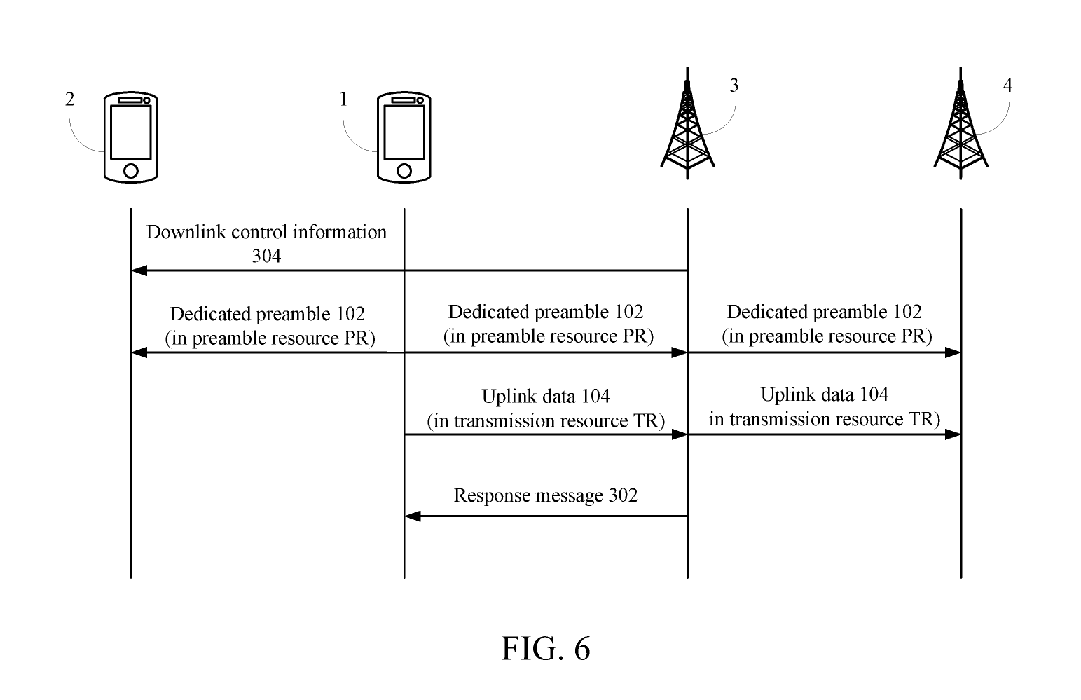

A fourth embodiment of the present invention is as shown in FIG. 6. FIG. 6 depicts an implementation scenario of data transmission among the user equipment 1, the user equipment 2, the base station 3 and a base station 4 according to the present invention. The fourth embodiment is also an extension of the second embodiment. In this embodiment, the dedicated preamble 102 is further received by another base station 4, so the base station 4 can also know the transmission resource TR used for transmitting the uplink data 104 by the user equipment 1. The base station 3 is the base station serving the user equipment 1 (i.e., a radio resource control connection has been established between the base station 3 and the user equipment 1), so theoretically the base station 3 should be the base station mainly receiving the uplink data 104. However, in some practical situations (e.g., where the user equipment 1 is at the boundary between the signal coverages of the base station 3 and the base station 4, or a deep fading phenomenon occurs right in the preamble resource PR and the transmission resource TR for the wireless channel between the base station 3 and the user equipment 1), the base station 4 can assist the base station 3 in receiving the uplink data 104.

Additionally, before receiving the uplink data 104, the base station 3 and the base station 4 may decide which one to receive the uplink data 104 based on a received signal strength of the dedicated preamble 102 that is received previously. For example, if the received signal strength of the dedicated preamble 102 received by the base station 3 is larger than the received signal strength of the dedicated preamble 102 received by the base station 4, then the base station 3 decides to receive the uplink data 104 and performs subsequent operations of transmitting the response messages 302 and 308 and re-allocating the uplink resource. On the contrary, if the received signal strength of the dedicated preamble 102 received by the base station 4 is larger than the received signal strength of the dedicated preamble 102 received by the base station 3, then the base station 4 receives the uplink data 104 and provides the uplink data 104 to the base station 3. Alternatively, the user equipment 1 is further handed over from the base station 3 to the base station 4, and the base station 4 provides the subsequent service (e.g., allocating the uplink resource and transmitting the response messages 302 and 308) for the user equipment 1.

It shall be appreciated that, in practical situations, each of various base stations adjacent to the user equipment 1 may receive the dedicated preamble 102 transmitted by the user equipment 1, and only one single base station 4 is taken as example for illustration in this embodiment. However, the implementation in which a plurality of base stations receive the dedicated preamble 102 shall be appreciated by those of ordinary skill in the art based on the explanation of this embodiment, and thus will not be further described herein. Additionally, the base stations capable of receiving the dedicated preamble 102 and the uplink data 104 from the user equipment 1 (e.g., the base station 3 and the base station 4) can also perform data demodulation cooperatively (i.e., perform cooperative modulation) so as to improve the probability of correctly decoding the uplink data 104. For example, the base station 4 may transmit the dedicated preamble 102 and the uplink data 104 received to the base station 3 (e.g., via an X2 interface defined by the LTE mobile communication system).

It shall be appreciated that, in the aforesaid embodiments, it is assumed that the share resource pool is a part of an uplink resource pool (i.e., an uplink channel) configured by the base station 3, i.e., the share resource pool is used by the base station 3 for allocating a dedicated resource (i.e., a dedicated uplink resource) to the eMBB user equipment or the URLLC user equipment to achieve uplink resource transmission and used by the URLLC user equipment for uplink grant-free transmission. However, in other embodiments, the share resource pool may also be a part of a downlink resource pool (i.e., a downlink channel) configured by the base station 3. In other words, the share resource pool may also be used by the base station 3 for allocating a dedicated resource (i.e., a dedicated downlink resource) to the eMBB user equipment or the URLLC user equipment to receive downlink data and used by the URLLC user equipment for uplink grant-free transmission.

In this case, the dedicated preamble 102 also serves as a preemption transmission request of the selected transmission resource TR. If the at least one other user equipment is a URLLC user equipment, the base station 3 suspends the allocation of the transmission resource TR selected by the user equipment 1 to the at least one other user equipment. If the at least one other user equipment is an eMBB use equipment, and the base station 3 has allocated a downlink resource which is at least partly overlapped with the transmission resource selected by the user equipment 1, then the base station 3 suspends the transmission with the at least one other user equipment (i.e., the base station 3 will not transmit downlink data to be transmitted to the at least one other user equipment in the downlink resource) and the base station 3 may re-allocate a downlink resource to transmit the downlink data to the at least one user equipment. If the base station 3 has not allocated a downlink resource to the at least one user equipment, then the base station 3 will not allocate the resource overlapped with the transmission resource TR to the at least one other user equipment. Various implementation scenarios where the share resource pool is a part of the downlink resource pool configured by the base station 3 shall be appreciated by those of ordinary skill in the art based on the above descriptions, and thus will not be further described herein.

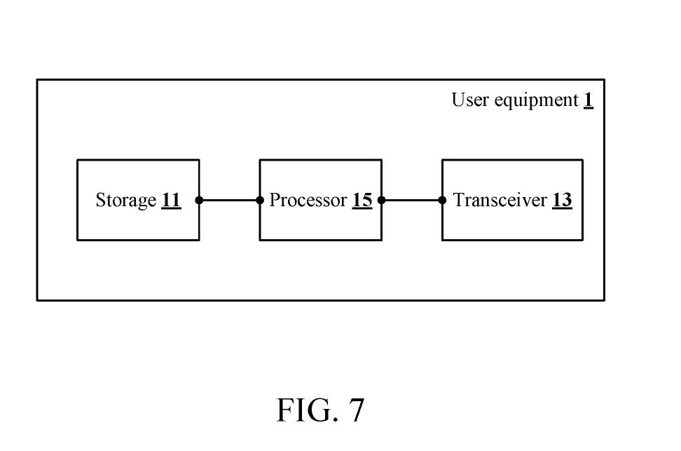

A fifth embodiment of the present invention is as shown in FIG. 7, which is a schematic view of the user equipment 1 supporting the URLLC service according to the present invention. The user equipment 1 comprises a storage 11, a transceiver 13 and a processor 15. The storage 11 stores a plurality of preambles including a dedicated preamble. The processor 15 is electrically connected to the storage 11 and the transceiver 13. As described in the first embodiment, the processor 13 is configured to select a transmission resource TR from a share resource pool. The share resource pool is configured for use by the user equipment 1 and at least one other user equipment. The at least one other user equipment supports the URLLC service or the eMBB service. Next, the processor 15 transmits the dedicated preamble 102 in the preamble resource PR corresponding to the transmission resource TR via the transceiver 13 so that the base station 3 suspends an allocation and transmission procedure of the transmission resource TR for the at least one other user equipment after receiving the dedicated preamble 102. Thereafter, the processor 15 transmits the uplink data 104 in the transmission resource TR via the transceiver 13 so that the base station 3 transmits a response message 302 to the user equipment 1 after receiving the uplink data 104.

Additionally, as in the implementation scenario of FIG. 2, the processor 15 selects the transmission resource TR according to downlink control information 304 after receiving the downlink control information 304 in a physical downlink control channel (PDCCH) via the transceiver 13. The downlink control information 304 indicates at least one uplink resource allocated by the base station 3 to the at least one other user equipment, and the at least one uplink resource is not overlapped with the transmission resource TR. Moreover, as described in the aforesaid embodiments, the dedicated preamble 102 indicates a preemption transmission request so that the base station 3 suspends the allocation and transmission procedure of the transmission resource associated with the at least one other user equipment.

In other embodiments, the at least one other user equipment includes another user equipment supporting the eMBB service (e.g., the user equipment 2 in the aforesaid embodiments), and the base station 3 has allocated an uplink resource to the user equipment 2 before receiving the dedicated preamble 102. In this case, if the user equipment 2 is capable of receiving the dedicated preamble 102 to determine that the allocated uplink resource is at least partly overlapped with the transmission resource TR, then the user equipment 2 voluntarily suspends an uplink data transmission using the uplink resource allocated to prevent transmission collision.

In other embodiments, the response message 302 carries receiving report information that indicates whether the base station 3 has successfully received the uplink data from the user equipment 1 (as described in the third embodiment). If the base station 3 fails to successfully receive the uplink data from the user equipment 1, the response message 302 further comprises uplink resource allocation information for use by the user equipment 1 to re-transmit the uplink data 104. Moreover, in other embodiments, the dedicated preamble 102 may indicate an uplink resource request, and the response message 302 may further comprise uplink resource allocation information. Additionally, as described in the aforesaid embodiments, the dedicated preamble 102 is allocated by the base station to represent an identification (ID) of the user equipment. Therefore, the base station can learn the user equipment 1 corresponding to the dedicated preamble 102 after receiving the dedicated preamble 102.

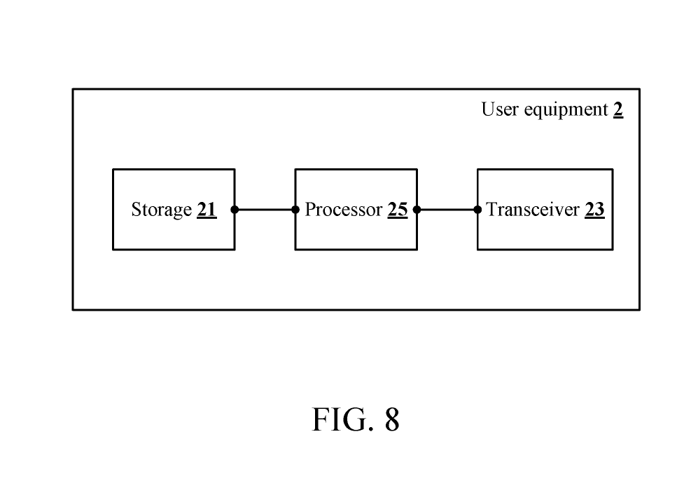

A sixth embodiment of the present invention is as shown in FIG. 8, which is a schematic view of the user equipment 2 supporting the eMBB service according to the present invention. The user equipment 2 comprises a storage 21, a transceiver 23 and a processor 25. The processor 25 is electrically connected to the storage 21 and the transceiver 23. The processor 25 is configured to receive downlink control information 304 in a physical downlink control channel via the transceiver 23, and the downlink control information 304 indicates an uplink resource allocated by the base station 3. Next, the processor 25 receives a preemption notification message via the transceiver 23, and suspends an uplink data transmission using the uplink resource allocated according to the preemption notification message. The processor 25 may perform the subsequent uplink data transmission, i.e., transmit the uplink data 202, based on a response message 308 after receiving the response message 308 from the base station via the transceiver 23. For example, as described in the third embodiment, the response message 308 carries preemption release information, and the processor 25 may continue the uplink data transmission via the transceiver 23 based on the preemption release information after receiving the response message 308. Moreover, the response message 308 may further carry information of another uplink resource re-allocated by the base station 3, so the processor 25 may transmit the uplink data 202 in the uplink resource newly allocated via the transceiver 23.

In other embodiments, the storage 21 stores a plurality of preambles including a dedicated preamble. The preemption notification message is the dedicated preamble, transmitted by another user equipment supporting the URLLC service, that indicates a preemption transmission request (e.g., the dedicated preamble 102 transmitted by the user equipment 1). As described previously, the dedicated preamble 102 is transmitted in the preamble resource PR, and the user equipment 1 further transmits the uplink data 104 to the base station 3 in the transmission resource TR corresponding to the preamble resource PR, and the uplink resource allocated to the user equipment 2 and the transmission resource TR are all included in a resource pool and at least partly overlapped with each other.

Moreover, in other embodiments, the preemption notification message is received from the base station 3, i.e., the preemption notification message 306 as shown in FIG. 3. In the case where the transmission resource TR is at least partly overlapped with the uplink resource allocated to the user equipment 2, the base station 3 transmits the preemption notification message 306 to the user equipment 2 after receiving the dedicated preamble 102 from the user equipment 1 that supports the URLLC service, in order to prevent the user equipment 2 from continuing to use the uplink resource allocated because the user equipment 2 has not received the dedicated preamble 102 or cannot receive the dedicated preamble 102 because the user equipment 2 does not support the function of receiving signals in the uplink channel.

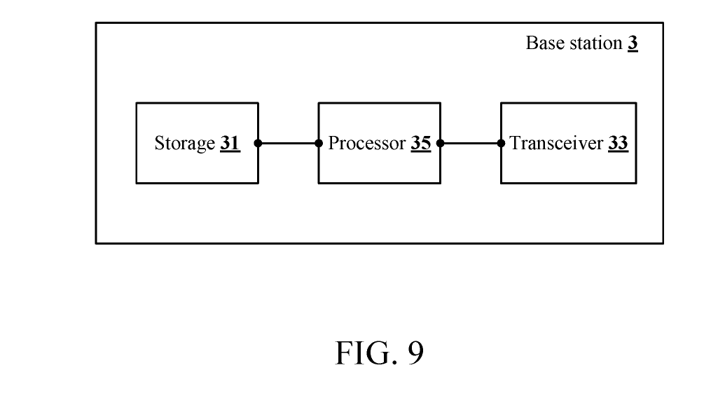

A seventh embodiment of the present invention is as shown in FIG. 9. FIG. 9 is a schematic view of the base station 3 according to the present invention. The base station 3 comprises a storage 31, a transceiver 33 and a processor 35. The processor 35 is electrically connected to the storage 31 and the transceiver 33. The processor 35 receives a dedicated preamble 102 in the preamble resource PR via the transceiver 33, and the dedicated preamble 102 is transmitted by a user equipment that supports the URLLC service (e.g., the user equipment 1 of the aforesaid embodiments). As described previously, the dedicated preamble 102 may be allocated to the user equipment 1 by the processor 35 to represent an ID of the user equipment 1.

Next, the processor 35 receives the uplink data 104 transmitted by the user equipment 1 in the transmission resource TR corresponding to the preamble resource PR according to the dedicated preamble 102, and suspends an allocation and transmission procedure of the transmission resource TR for at least one other user equipment according to the dedicated preamble 102. The at least one other user equipment supports the URLLC service or the eMBB service. The processor 35 determines whether the uplink data 104 is correctly received so as to transmit a response message 302 to the user equipment 1.

In other embodiments, the processor 35 transmits downlink control information to another user equipment supporting the eMBB service (e.g., the user equipment 2 of the aforesaid embodiments) among the at least one other user equipment in a physical downlink control channel via the transceiver 33 before receiving the dedicated preamble 102. Because the downlink control information indicates an uplink resource allocated to the another user equipment, and the uplink resource is at least partly overlapped with the transmission resource, the processor 35 suspends the allocation and transmission procedure of the transmission resource associated with the at least one other user equipment in response to the preemption transmission request indicated by the dedicated preamble 102, as described in the second embodiment and the third embodiment.

In other embodiments, the processor 35 further generates and transmits a preemption notification message 306 to the another user equipment in response to receiving the dedicated preamble 102 so that the another user equipment suspends an uplink data transmission using the uplink resource in response to the preemption notification message 306 (as shown in FIG. 3). Moreover, in other embodiments, the processor 35 further transmits another response message to the another user equipment (e.g., in the implementation scenario of FIG. 4, transmits a response message 308 to the user equipment 2) via the transceiver 33. As described previously, the response message 308 carries preemption release information, so the user equipment 2 may continue the uplink data transmission based on the preemption release information. Furthermore, as described previously, the response message 308 further carries information of an uplink resource that is re-allocated.

Moreover, as described in the third embodiment, the response message 302 transmitted to the user equipment 1 carries receiving report information that indicates whether the base station 3 has successfully received the uplink data 104 from the user equipment 1. If the base station 3 fails to successfully receive the uplink data 104 from the user equipment 1, the response message 302 may further comprise uplink resource allocation information for use by the user equipment 1 to re-transmit the uplink data 104. In other embodiments, the dedicated preamble 102 may indicate an uplink resource request. The uplink resource request may further inform the base station 3 of the resource size required by the user equipment 1 for subsequent uplink data transmission. The processor 35 further allocates an uplink resource to the user equipment 1 in response to the uplink resource request, so the response message 302 further comprises uplink resource allocation information that indicates the uplink resource allocated.

Additionally, in other embodiments, the processor 35 further determines a received signal strength of the dedicated preamble 102 and receives another received signal strength from another base station (e.g., the base station 4 of the fourth embodiment) via the transceiver 33, and the another received signal strength is determined by the another base station based on receiving the dedicated preamble 102. In this case, the processor 35 further determines whether the received signal strength of the dedicated preamble 102 that is received by the base station 3 is greater than the received signal strength of the dedicated preamble 102 that is received by the base station 4. If the determination result is yes, then the base station 3 receives the uplink data 104. Moreover, in another embodiment, the processor 35 may further receive the uplink data 104 received by the base station 4 from the another base station (e.g., the base station 4 of the fourth embodiment) via the transceiver 33 so as to perform a cooperative demodulation on the uplink data 104 and the uplink data received from the processor 35.

According to the above descriptions, the data transmission mechanism of the present invention enables a URLLC user equipment to directly transmit uplink data in the transmission resource selected by the URLLC user equipment itself without the need of first requesting the transmission resource from the base station, and a dedicated preamble indicating a preemption transmission request of the transmission resource selected by the user equipment is transmitted to achieve the purpose of preempting the transmission resource. Therefore, the data transmission mechanism of the present invention can satisfy the transmission requirements of the URLLC service and further improve the resource utilization ratio and transmission reliability without causing transmission resource collision. Moreover, the present invention uses the dedicated preamble as a beacon and for channel measurement, and not only the base station originally serving the URLLC user equipment can receive the uplink data transmitted by the URLLC user equipment, but other base stations surrounding the URLLC user equipment which are capable of receiving the dedicated preamble can also assist in receiving the uplink data, thereby increasing the probability of successfully receiving the uplink data transmitted by the URLLC user equipment.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A user equipment supporting an ultra-reliable low latency communication (URLLC) service, comprising:
a storage, storing a plurality of preambles including a dedicated preamble;
a transceiver; and
a processor electrically connected to the storage and the transceiver, being configured to execute the following operations:
selecting a transmission resource from a share resource pool that is configured for use by the user equipment and at least one other user equipment, the at least one other user equipment supporting the URLLC service or an enhanced mobile broadband (eMBB) service;
transmitting the dedicated preamble in a preamble resource corresponding to the transmission resource via the transceiver so that a base station suspends an allocation and transmission procedure of the transmission resource for the at least one other user equipment after receiving the dedicated preamble; and
transmitting an uplink data in the transmission resource via the transceiver so that the base station transmits a response message to the user equipment after receiving the uplink data.

2. The user equipment of claim 1, wherein the processor selects the transmission resource according to downlink control information after receiving the downlink control information in a physical downlink control channel (PDCCH) via the transceiver, the downlink control information indicates at least one uplink resource allocated by the base station to the at least one other user equipment, and the transmission resource is not overlapped with the at least one uplink resource.

3. The user equipment of claim 1, wherein the at least one other user equipment includes another user equipment, the another user equipment supports the eMBB service, the base station allocates an uplink resource to the another user equipment before receiving the dedicated preamble, the another user equipment further receives the dedicated preamble to suspend an uplink data transmission using the uplink resource, and the uplink resource is at least partly overlapped with the transmission resource.

4. The user equipment of claim 1, wherein the response message carries receiving report information indicating whether the base station has successfully received the uplink data from the user equipment.

5. The user equipment of claim 4, wherein when the base station fails to successfully receive the uplink data from the user equipment, the response message further includes uplink resource allocation information for use by the user equipment to re-transmit the uplink data.

6. The user equipment of claim 4, wherein the dedicated preamble indicates an uplink resource request, and the response message further includes uplink resource allocation information.

7. The user equipment of claim 1, wherein the dedicated preamble is allocated by the base station to represent an identification (ID) of the user equipment.

8. A user equipment supporting an enhanced mobile broadband (eMBB) service, comprising:
a storage;
a transceiver; and
a processor electrically connected to the storage and the transceiver, being configured to execute the following operations:
receiving downlink control information in a physical downlink control channel via the transceiver, the downlink control information indicating an uplink resource allocated by a base station;
receiving a preemption notification message via the transceiver, and suspending an uplink data transmission using the uplink resource according to the preemption notification message; and
receiving a response message from the base station via the transceiver so as to perform the uplink data transmission according to the response message.

9. The user equipment of claim 8, wherein the storage stores a plurality of preambles including a dedicated preamble, and the preemption notification message is the dedicated preamble transmitted by another user equipment supporting an ultra-reliable low latency communication (URLLC) service, the dedicated preamble indicates a preemption transmission request and is transmitted in a preamble resource, the another user equipment further transmits an uplink data to the base station in a transmission resource corresponding to the preamble resource, and the uplink resource and the transmission resource are included in a share resource pool and at least partly overlapped with each other.

10. The user equipment of claim 8, wherein the preemption notification message is received from the base station, and the base station transmits the preemption notification message after receiving a dedicated preamble from another user equipment supporting a URLLC service;
wherein the dedicated preamble indicates a preemption transmission request of a transmission resource, and the transmission resource and the uplink resource are included in a share resource pool and at least partly overlapped with each other.

11. The user equipment of claim 8, wherein the response message carries preemption release information.

12. The user equipment of claim 11, wherein the response message further carries information of another uplink resource re-allocated by the base station.

13. A base station, comprising:
a storage;
a transceiver; and
a processor electrically connected to the storage and the transceiver, being configured to execute the following operations:
receiving a dedicated preamble in a preamble resource via the transceiver, the dedicated preamble being transmitted by a user equipment supporting an ultra-reliable low-latency communication (URLLC) service;
receiving an uplink data transmitted by the user equipment in a transmission resource corresponding to the preamble resource according to the dedicated preamble;
suspending an allocation and transmission procedure of the transmission resource for at least one other user equipment according to the dedicated preamble, the at least one other user equipment supporting the URLLC service or an enhanced mobile broadband (eMBB) service; and
determining whether the uplink data is correctly received to transmit a response message to the user equipment;
wherein the transmission resource is included in a share resource pool configured for use by the user equipment and the at least one other user equipment.

14. The base station of claim 13, wherein the processor transmits downlink control information to another user equipment among the at least one other user equipment in a physical downlink control channel via the transceiver before receiving the dedicated preamble, the another user equipment supports the eMMB service, the downlink control information indicates an uplink resource allocated to the another user equipment, and the uplink resource is at least partly overlapped with the transmission resource.

15. The base station of claim 14, wherein the processor further generates a preemption notification message to the another user equipment in response to receiving the dedicated preamble so that the another user equipment suspends an uplink data transmission using the uplink resource in response to the preemption notification message.

16. The base station of claim 14, wherein the processor further transmits another response message to the another user equipment via the transceiver, and the another response message carries preemption release information.

17. The base station of claim 13, wherein the response message further carries information of a re-allocated uplink resource.

18. The base station of claim 13, wherein the response message carries receiving report information indicating whether the base station has successfully received the uplink data from the user equipment.

19. The base station of claim 18, wherein when the base station fails to successfully receive the uplink data from the user equipment, the response message further includes uplink resource allocation information for use by the user equipment to re-transmit the uplink data.

20. The base station of claim 18, wherein the dedicated preamble indicates an uplink resource request, the processor further allocates an uplink resource to the user equipment in response to the uplink resource request, and the response message further includes uplink resource allocation information indicating the uplink resource.

21. The base station of claim 13, wherein the processor further determines a received signal strength of the dedicated preamble and receives another received signal strength from another base station via the transceiver, and the another received signal strength is determined by the another base station based on receiving the dedicated preamble;
wherein the processor further determines that the received signal strength is greater than the another received signal strength to receive the uplink data.

22. The base station of claim 13, wherein the processor further receives the uplink data received by the another base station from the another base station via the transceiver so as to perform a cooperative demodulation on the uplink data received from the another base station and the uplink data received from the user equipment.

23. The base station of claim 13, wherein the processor further allocates the dedicated preamble to the user equipment to represent an identification (ID) of the user equipment.
